(19) United States
(12) Patent Application Publication
(10) Pub. No.: US 2023/0152018 A1
(43) Pub. Date: May 18, 2023

(54) METHOD OF OPERATING A REFRIGERANT COMPRESSOR

(71) Applicant: Carrier Corporation, Palm Beach Gardens, FL (US)

(72) Inventors: Charles A. Cluff, Zionsville, IN (US); Derek A. Leman, Brownsburg, IN (US)

(21) Appl. No.: 18/055,157

(22) Filed: Nov. 14, 2022

Related U.S. Application Data
(60) Provisional application No. 63/264,050, filed on Nov. 15, 2021.

(51) Int. Cl. F25B 49/02

(52) U.S. Cl. CPC F25B 49/022; F25B 2500/26; F25B 2600/0252

(57) ABSTRACT

A method of operating a vapor compression system configured for environmentally conditioning a space comprising: providing a compressor of the vapor compression system with a variable speed drive, operating the compressor at a first speed in response to a start command, determining a demand speed of the compressor based at least in part on a user selected target value for an environmental condition within the space, determining a maximum allowable compressor speed of the compressor based at least in part on a condition of a parameter of the vapor compression system, reducing the speed of the compressor from the first speed to a second speed, maintaining the speed of the compressor below the first speed, and operating the compressor at the demand speed once a startup condition is satisfied.

### BACKGROUND

Exemplary embodiments pertain to the art of vapor compression systems. More particularly, the present disclosure relates to methods of starting compressors of vapor compression systems.

A vapor compression cycle can be deployed in air conditioning, refrigeration, and heat pump systems. These systems can utilize a variable speed refrigerant compressor that adjusts the compression rate to meet the thermal output demanded from the system. Although these systems can be designed to follow the thermal demand, e.g., deploy active control methods to compensate for changing thermal demand, under some conditions the operating boundaries can be more restrictive in order to prevent unwanted conditions from developing or persisting in the vapor compression cycle. Accordingly, there remains a need in the art for methods of operating vapor compression systems that maintain cycle conditions within the desired ranges to reduce undue wear on system components.

### BREIF DESCRIPTION

Disclosed is a method of operating a vapor compression system configured for environmentally conditioning a space comprising: providing a compressor of the vapor compression system with a variable speed drive configured to control a speed of the compressor and correspondingly a flowrate of a refrigerant flowing through the compressor, operating the compressor at a first speed in response to a start command, determining a demand speed of the compressor based at least in part on a user selected target value for an environmental condition within the space, determining a maximum allowable compressor speed of the compressor based at least in part on a condition of a parameter of the vapor compression system, reducing the speed of the compressor from the first speed to a second speed corresponding to the maximum allowable compressor speed when the maximum allowable compressor speed is less than the first speed, maintaining the speed of the compressor below the first speed when the maximum allowable compressor speed is greater than the first speed, and operating the compressor at the demand speed once a startup condition is satisfied.

In addition to one or more of the above disclosed aspects or as an alternate, wherein the maintaining the speed of compressor below the first speed further comprises operating the compressor at the demand speed when the demand speed is greater than the second speed.

In addition to one or more of the above disclosed aspects or as an alternate, wherein the maintaining the speed of the compressor below the first speed further comprises operating the compressor at the second speed when the demand speed is less than the second speed.

In addition to one or more of the above disclosed aspects or as an alternate, wherein the startup condition comprises increasing a discharge superheat value of the vapor compression system to a threshold discharge superheat value.

In addition to one or more of the above disclosed aspects or as an alternate, wherein the startup condition comprises waiting for a first time period to expire.

In addition to one or more of the above disclosed aspects or as an alternate, wherein the startup condition comprises increasing a discharge superheat value of the vapor compression system to a threshold discharge superheat value and waiting for a first time period to expire.

In addition to one or more of the above disclosed aspects or as an alternate, wherein the determining the maximum allowable compressor speed of the compressor further comprises comparing at least one of a suction pressure of the compressor, a discharge pressure of the compressor, a compression ratio of the compressor, a compressor discharge temperature, or a combination comprising at least one of the foregoing to a threshold condition.

In addition to one or more of the above disclosed aspects or as an alternate, wherein the reducing the speed of the compressor further comprises decreasing the speed of the compressor according to a downward ramp rate.

In addition to one or more of the above disclosed aspects or as an alternate, wherein operating the compressor at the demand speed further comprises adjusting the speed of the compressor according to an upward or downward ramp rate from the second speed to the demand speed.

In addition to one or more of the above disclosed aspects or as an alternate, wherein the upward ramp rate and the downward ramp rate have the same magnitude but opposite signs.

In addition to one or more of the above disclosed aspects or as an alternate, wherein the condition of the parameter of the vapor compression system comprises a high suction pressure of the compressor, a low suction pressure of the compressor, a high discharge pressure of the compressor, a low discharge pressure of the compressor, a high compression ratio of the compressor, a low compression ratio of the compressor, a low compressor discharge temperature, a high compressor discharge temperature, or a combination comprising at least one of the foregoing.

Also disclosed is a vapor compression system configured for environmentally conditioning a space comprising: a compressor, an indoor heat exchanger, and outdoor heat exchanger, and an expansion valve disposed in a closed loop in operable communication with one another, wherein the indoor heat exchanger is disposed in thermal communication with the space, a variable speed drive disposed in operable communication with the compressor and configured for adjusting a speed of the compressor, and a controller in operable communication with the variable speed drive and a sensor configured to determine a condition of a parameter of the closed loop, wherein the controller is configured to operate the vapor compression system according to the method of any one of the preceding claims.

Also disclosed is a vapor compression system configured for environmentally conditioning a space comprising: a compressor, an indoor heat exchanger, and outdoor heat exchanger, and an expansion valve disposed in a closed loop in operable communication with one another, wherein the indoor heat exchanger is disposed in thermal communication with the space, a variable speed drive disposed in operable communication with the compressor and configured for adjusting a speed of the compressor, a controller in operable communication with the variable speed drive and a sensor configured to determine a condition of a parameter of the closed loop, wherein the controller is configured to determine a demand speed of the compressor based at least in part on a user selected target value for an environmental condition within the space, determine a maximum allowable compressor speed of the compressor based at least in part on the condition of the parameter, reduce the speed of the compressor from a first speed to a second speed corresponding to the maximum allowable compressor speed when the maximum allowable compressor speed is less than the first speed, maintain the speed of the compressor below the first speed when the maximum allowable compressor speed is greater than the first speed, and operate the compressor at the demand speed once a startup condition is satisfied.

In addition to one or more of the above disclosed aspects or as an alternate, wherein the controller is configured to operate the compressor at the demand speed when the demand speed is greater than the second speed.

In addition to one or more of the above disclosed aspects or as an alternate, wherein the controller is configured to operate the compressor at the second speed when the demand speed is less than the second speed.

In addition to one or more of the above disclosed aspects or as an alternate, wherein the startup condition comprises a discharge superheat value of the vapor compression system being greater than or equal to a threshold discharge superheat value.

In addition to one or more of the above disclosed aspects or as an alternate, wherein the startup condition further comprises waiting for a first time period to expire.

In addition to one or more of the above disclosed aspects or as an alternate, wherein the startup condition comprises a discharge superheat value of the vapor compression system being greater than or equal to a threshold discharge superheat value and waiting for a first time period to expire.

In addition to one or more of the above disclosed aspects or as an alternate, wherein the controller is configured to determine the maximum allowable compressor speed by comparing at least one of a suction pressure of the compressor, a discharge pressure of the compressor, a compression ratio of the compressor, a compressor discharge temperature, or a combination comprising at least one of the foregoing to a threshold condition.

### BRIEF DESCRIPTION OF THE DRAWINGS

The following descriptions should not be considered limiting in any way. With reference to the accompanying drawings, like elements are numbered alike:

FIG. 1 is a schematic illustration of a vapor compression system configured as an air conditioning system.

FIG. 2 is a schematic illustration of a vapor compression system configured as a heat pump system.

FIG. 3 is a schematic illustration of a method of operating a vapor compression system.

FIG. 4 is a graphical illustration of operating parameters of the vapor compression system over time with and without implementation of the disclosed method.

FIG. 5 is a graphical illustration of operating parameters of the vapor compression system over time with and without implementation of the disclosed method where the demand speed is less than the second speed.

FIG. 6 is a graphical illustration of operating parameters of the vapor compression system over time with and without implementation of the disclosed method where the demand speed is greater than the second speed.

### DETAILED DESCRIPTION

A detailed description of one or more embodiments of the disclosed apparatus and method are presented herein by way of exemplification and not limitation with reference to the Figures.

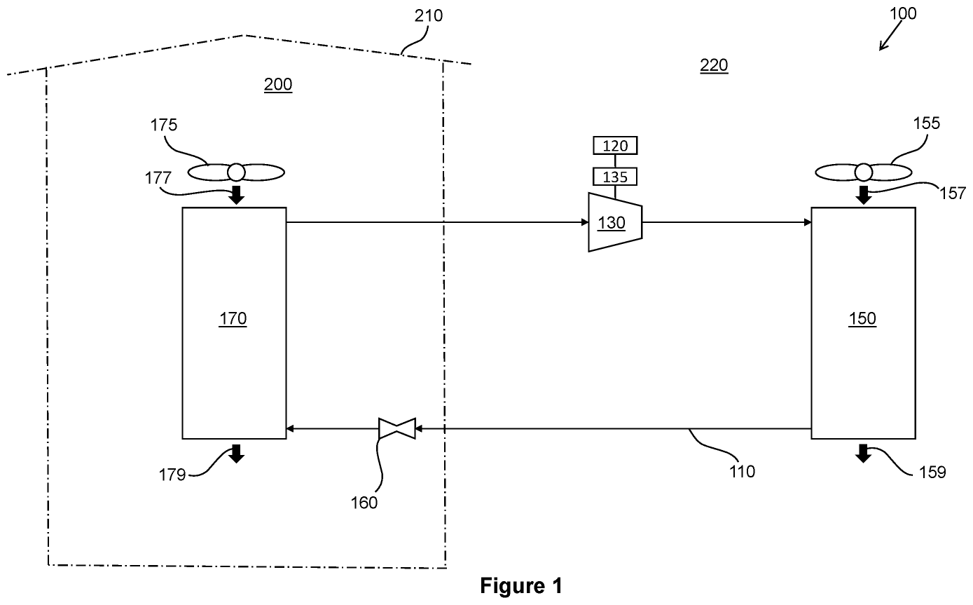

FIG. 1 is a schematic illustration of a vapor compression system 100 configured as an air conditioning system for providing cooling to an interior space 200 of a building 210. The vapor compression system 100 can have a compressor 130, an outdoor heat exchanger 150, an expansion valve 160, and an indoor heat exchanger 170 disposed in operable fluid communication sequentially around a refrigerant loop 110. The outdoor heat exchanger 150 can be placed in thermal communication with the ambient outdoor environment 220 and the indoor heat exchanger 170 can be placed in thermal communication with the interior space 200 to be environmentally conditioned within the building 210. An indoor air mover 175 (e.g., a fan or blower) can be configured to provide a return air stream 177 from within the building 210 to the indoor heat exchanger 170. The return air stream 177 can be cooled by the indoor heat exchanger 170 (correspondingly heating a refrigerant flow in the refrigerant loop 110) and distributed as a supply air stream 179 to the interior space 200 to be environmentally conditioned within the building 210. An outdoor air mover 155 (e.g., fan or blower) can be configured to provide an outdoor air supply stream 157 from the outside environment 220 to the outdoor heat exchanger 150 which can heat the air (correspondingly cooling the refrigerant flow) before it is returned to the outside environment 220 as an outdoor air exhaust stream 159. For example, the indoor heat exchanger 170 can be located within a furnace coil, fan coil, air handler, or the like, while the outdoor heat exchanger 150 is located on a rooftop, yard, or the like.

During operation of the vapor compression system 100, the compressor 130 can compress vapor phase refrigerant flow to a higher pressure and supply it to the outdoor heat exchanger 150. Outside air can be blown, or pulled, through the outdoor heat exchanger 150 to cool the refrigerant flow which can condense vapor phase refrigerant to a liquid phase. The cooled liquid refrigerant flow exiting the outdoor heat exchanger 150 can be expanded to a lower pressure as it passes through the expansion valve 160 and enters the indoor heat exchanger 170. This expansion can cause a portion of the refrigerant flow to vaporize and result in a vapor-liquid two-phase mixture exiting the expansion valve 160. Warmer air from the interior space 200 to be conditioned within the building 210 can be directed through the indoor heat exchanger 170 as return air stream 177 where it can be cooled and returned to the building 200 as a conditioned supply air stream 179 by heat transfer with the cold refrigerant passing through indoor heat exchanger 170.

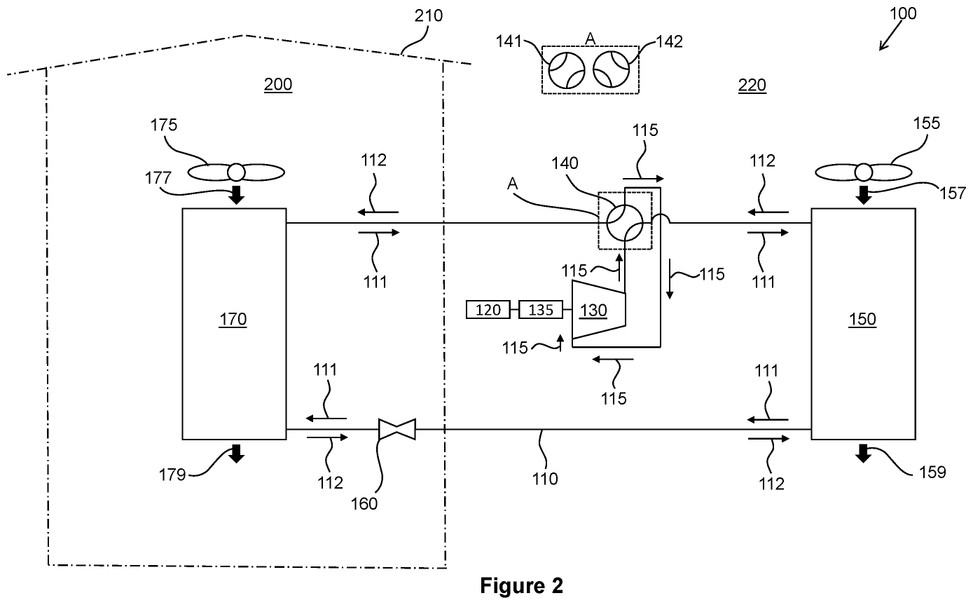

FIG. 2 is a schematic illustration of a vapor compression system 100 configured for operation as a heat pump system for providing cooling and heating to an interior space 200 of a building 210. The vapor compression system 100 can have a compressor 130, an outdoor heat exchanger 150, an expansion valve 160, and an indoor heat exchanger 170, and a four-way valve 140, disposed in operable fluid communication sequentially around the refrigerant loop 110. The heat pump can operate in a heating mode or a cooling mode depending on the direction of refrigerant flow around the refrigerant loop 110. The four-way valve 140 can be utilized to change the flow direction of a portion of the refrigerant loop 110 when changing from the heating mode to the cooling mode or vice versa. For example, when in a cooling mode, the four-way valve 140 can be set in a first position 141 (shown in detail A) where the refrigerant can be directed along a cooling mode flow path as indicated by cooling mode directional arrows 111 and mode independent directional arrows 115 and when in heating mode, the four-way valve 140 can be set in a second position 142 (shown in detail A) where the refrigerant can be directed along a heating mode flow path as indicated by heating mode directional arrows 112 and independent directional arrows 115.

The compressor 130 of the vapor compression system 100 can be configured for operation with input from a variable speed drive 135. Such a drive can vary its output speed (e.g., by varying output frequency) and consequently the speed of the compressor 130 and the flow rate of refrigerant through the compressor 130. Allowing for compressor speed adjustment can provide for more efficient system operation, e.g., under off-design conditions, partial thermal output conditions, startup conditions, full rated thermal output conditions, and the like. Additionally, use of the variable speed drive 135 to drive compressor 130 can allow for adjustment to the compressor speed in response to system events or disturbances.

A system controller 120 can be configured in operable communication with the variable speed drive 135 to control the compressor 130. The controller 120 can be configured to adjust the speed of the compressor 130 when one or more system parameters deviate from their predetermined operating envelop. For example, the system controller 120 can limit the compressor speed or command the variable speed drive 135 to limit the compressor speed to a maximum allowable compressor speed 440 when one or more system parameters deviate from their predetermined operating envelop. The one or more system parameters that can deviate from their predetermined operating envelop can include a suction pressure of the compressor 130 reaching a minimum value for a specified time duration, a discharge pressure of the compressor 130 reaching a maximum value for a specified time duration, the compression ratio of the compressor 130 reaching a minimum value for a specified time duration, the compression ratio of the compressor 130 reaching a maximum value for a specified time duration, the discharge pressure of the compressor 130 reaching a minimum value for a specified time duration, the discharge temperature of the compressor 130 reaching a minimum temperature for a specified time duration, or a combination including at least one of the foregoing.

Several different strategies for starting up the vapor compression system 100 having a variable speed driven compressor 130 can be employed. A method which can be implemented during startup operation can include operating the compressor 130 at a fixed speed, for a fixed time duration, until a startup condition is satisfied (e.g., until a target discharge superheat value is reached for a predetermined duration), or a combination including at least one of the foregoing. In situations where parameters of the vapor compression system 100 deviate from their predetermined operating envelop (e.g., stored in a memory storage device in operable communication with the controller 120) during startup, the controller 120 can be configured to command the compressor 130 to a different speed (e.g., lower speed) such that the parameter returns to within its predetermined operating envelop. For example, one situation that can arise is low compressor suction pressure (e.g., as measured at the inlet of the compressor 130). Under this condition the controller 120 can reduce the speed of the compressor 130 until the suction pressure returns to the predetermined operating envelop. However, a consequence of this, or other corrective actions, is they can further exacerbate the underlying issue that resulted in the low suction pressure to begin with. For example, by lowering the speed of the compressor 130 followed by returning to a higher, fixed, startup speed the discharge pressure of the compressor 130 can cycle from relatively lower to higher pressure. This pressure difference between high pressure and lower pressure can have a significant effect on the refrigerant solubility in lubricating oil used in the refrigerant loop 110 for lubricating the components of compressor 130. As a result, refrigerant in solution in the liquid oil phase can vaporize as the refrigerant solubility in the lubricant oil drops. Rapid volume expansion due to vaporization within the liquid oil phase can lead to oil foaming, a condition which can lead to premature failure of the compressor 130 due to reduced viscosity and lubricity of the lubricating oil.

During such startup operation, the controller 120 can be configured for operating the compressor 130 at a first speed until the startup condition is satisfied. For example, the startup condition can include achieving a target discharge superheat value greater than or equal to about 25° F., or greater than or equal to about 24° F., or greater than or equal to about 23° F., or greater than or equal to about 22° F., or greater than or equal to about 21° F., or greater than or equal to about 20° F., or greater than or equal to about 19° F., or greater than or equal to about 18° F., or greater than or equal to about 17° F., or greater than or equal to about 16° F., or greater than or equal to about 15° F., or greater than or equal to about 14° F., or greater than or equal to about 13° F., or greater than or equal to about 12° F., or greater than or equal to about 11° F., or greater than or equal to about 10° F., or greater than or equal to about 9° F., or greater than or equal to about 8° F., or greater than or equal to about 7° F., or greater than or equal to about 6° F., or greater than or equal to about 5° F., or greater than or equal to about 4° F., or greater than or equal to about 3° F., or greater than or equal to about 2° F., or greater than or equal to about 1° F.

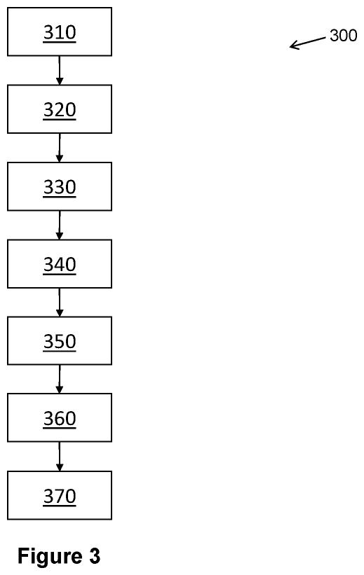

FIG. 3 is a schematic illustration of a method 300 of operating the vapor compression system 100 which is configured for environmentally conditioning a space 200. The method 300 can include a first aspect 310 including receiving a request for environmental conditioning the space 200 (e.g., from a user, a master device, or the like). For example, the method can include receiving a setpoint for an environmental condition (e.g., temperature, humidity, or the like) from a user interface (e.g., thermostat, mobile device, or the like), a supervisory controller, or the like.

The method 300 can include a second aspect 320 including starting the compressor 130 (e.g., following receiving the request for environmental conditioning of the space 200). Starting the compressor 130 can include operating the compressor 130 at a first speed (e.g., set to maintain a constant, fixed speed, setpoint within control tolerances of the variable speed drive 135). The first speed can be set to a percentage of the maximum speed. For example, the first speed can be greater than or equal to about 10% of the maximum speed of compressor 130, or greater than or equal to about 25% of the maximum speed of compressor 130, or greater than or equal to about 50% of the maximum speed of compressor 130, or greater than or equal to about 60% of the maximum speed of compressor 130, or greater than or equal to about 70% of the maximum speed of compressor 130, or greater than or equal to about 75% of the maximum speed of compressor 130, or greater than or equal to about 80% of the maximum speed of compressor 130, or greater than or equal to about 85% of the maximum speed of compressor 130. The maximum speed of the compressor 130 can correspond to the maximum rated speed of the compressor 130 as supplied by the manufacturer of the compressor 130.

The method 300 can include a third aspect 330 including determining a demand speed of the compressor 130. The demand speed of the compressor 130 is the speed that the compressor 130 of the vapor compression system 100 would run at based on the thermal demand placed on the vapor compression system 100. This thermal demand can be based, at least in part, on a user selected target value for an environmental condition within the space 200 (e.g., temperature, humidity, or the like). Determining the demand speed of the compressor 130 can include interpreting with the controller 120 the demand speed from a predefined relationship between thermal output of the vapor compression system 100 and at least compressor speed. Such relationship can be stored in the memory disposed in operable communication with the controller 120. The relationship can be stored in the form of a series of data points, an equation, or a combination thereof. Further, the relationship can be empirically determined as a function of one or more operating parameters of the vapor compression system 100, e.g., by testing or simulating operation (e.g., using a physics-based computer aided model) over a variety of environmental conditions.

The method 300 can include a fourth aspect 340 including determining a maximum speed of the compressor 130. The maximum speed of the compressor 130 can be based at least in part on a condition of a parameter of the vapor compression system. For example, the controller 120 can monitor one or more parameters of the vapor compression system 100 for deviation from expected ranges. If a parameter reaches a threshold condition then the controller 120 can reduce the operating window of the compressor 130 to prevent damage to the compressor 130 (e.g., liquid ingestion). For example, the condition of a parameter can include a suction pressure of the compressor 130 reaching a minimum value for a specified time duration, a discharge pressure of the compressor 130 reaching a maximum value for a specified time duration, the compression ratio of the compressor 130 reaching a minimum value for a specified time duration, the compression ratio of the compressor 130 reaching a maximum value for a specified time duration, the discharge pressure of the compressor 130 reaching a minimum value for a specified time duration, the discharge temperature of the compressor 130 reaching a minimum temperature for a specified time duration, or a combination including at least one of the foregoing. The condition of these parameters can therefore influence the determination of the maximum allowable compressor speed at any given time during operation.

The method 300 can include a fifth aspect 350 including reducing the speed of the compressor 130 from the first speed to a second speed corresponding to the maximum allowable compressor speed when the maximum allowable compressor speed is less than the first speed. If, during operation at the first speed, the controller 120 determines the maximum allowable compressor speed is reduced below the first speed then the controller 120 can reduce the speed of the compressor 130 to be equal to or less than the maximum allowable compressor speed, e.g., by reducing the speed of the variable speed drive 135. However, instead of allowing the compressor 130 to return to the first speed to finish the startup when the parameter returns within the expected operating range, the applicants have found that maintaining the speed of the compressor 130 at or near the second speed can at least reduce the occurrence of compressor pressure cycling and resultant oil foaming.

Accordingly, the method 300 can include a sixth aspect 360 including maintaining the speed of the compressor 130 below the first speed when the maximum allowable compressor speed is greater than the first speed. For example, after the speed of the compressor 130 is reduced to the second speed, the controller 120 can operate to maintain the speed of the compressor 130 (e.g., through the variable speed drive 135) at or near the second speed even when the maximum allowable speed of the compressor 130 returns to values greater than the first speed. By maintaining the speed of the compressor 130 at or near the second speed, pressure disturbances throughout the refrigerant loop can be reduced and consequent changes in refrigerant solubility in lubricant oil can be minimized while the startup operation proceeds until satisfying the startup condition. Furthermore, in instances where the demand speed is near the second speed, the controller 120 can be configured to operate the compressor 130 at the demand speed. For example, the controller 120 can be configured to operate the compressor 130 at the demand speed when the difference between the demand speed and the second speed is less than or equal to about 10% of the maximum speed of the compressor 130, such as less than or equal to about 9% of the maximum speed of the compressor 130, or less than or equal to about 8% of the maximum speed of the compressor 130, or less than or equal to about 7% of the maximum speed of the compressor 130, or less than or equal to about 6% of the maximum speed of the compressor 130, or less than or equal to about 5% of the maximum speed of the compressor 130, or less than or equal to about 4% of the maximum speed of the compressor 130, or less than or equal to about 3% of the maximum speed of the compressor 130, or less than or equal to about 2% of the maximum speed of the compressor 130, or less than or equal to about 1% of the maximum speed of the compressor 130, or such as less than or equal to about 1000 rpm, or less than or equal to about 800 rpm, or less than or equal to about 600 rpm or less than or equal to about 500 rpm, or less than or equal to about 405 rpm, or less than or equal to about 300 rpm, or less than or equal to about 200 rpm, or less than or equal to about 100 rpm, or less than or equal to about 50 rpm.

Still further, maintaining the speed of the compressor 130 below the first speed can include operating the compressor 130 at the demand speed when the demand speed is greater than the second speed. For example, maintaining the speed of the compressor 130 below the first speed can include operating the compressor 130 at the demand speed when the demand speed is greater than the second speed and less than the first speed. Maintaining the speed of the compressor 130 below the first speed can further include operating the compressor 130 at the demand speed when the demand speed is less than the second speed and less than the first speed. As disclosed herein, the controller 120 can be configured to operate the compressor 130 at the demand speed when the demand speed is near the second speed and below the first speed. Operating at the demand speed can include increasing or decreasing the speed of the compressor 130 to follow the thermal demand of the vapor compression system 100. During the startup operation, e.g., before the startup threshold condition is satisfied, operating the compressor 130 at the demand speed can further include operating the compressor 130 at a speed less than or equal to the first speed.

The method 300 can include a seventh aspect 370 of operating the compressor 130 (e.g., via the variable speed drive 135) at the demand speed S_{D} once the startup condition is satisfied. The startup condition can include achieving the target discharge superheat value (e.g., as discussed above) which can be a function of the architecture of the vapor compression system 100, the type of compression technology employed in the compressor 130, the specific design of the compressor 130, or a combination including at least one of the foregoing.

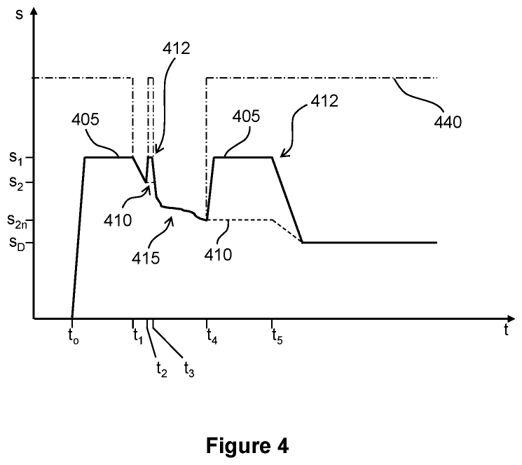

FIG. 4 is a schematic illustration of a graph of operating parameters of the vapor compression system 100 over time with and without implementation of method 300. The compressor speed without implementation 405 is denoted by the solid line, the maximum allowable compressor speed 440 (e.g., as determined by the controller 120 based on conditions of the refrigerant loop 110) is denoted by the dot-dashed line, and the compressor speed with implementation 410 is denoted by the dashed line. The demand speed is indicated by S_{D} and the first speed is indicated by S₁. At the time to the compressor 130 starts and the speed of the compressor 130 is increased to the first speed, S₁. Both the compressor speed without implementation 405 and the compressor speed with implementation 410 initially track the first speed until at t₁ the maximum allowable compressor speed 440 drops below the first speed S₁. The two traces (405 and 410) continue to follow the maximum allowable compressor speed 440 as it decreases until t₂ when the maximum allowable compressor speed 440 becomes greater than the first speed S₁. At that point, the compressor speed without implementation 405 increases back to the first speed S₁ while the compressor speed with implementation 410 remains at the second speed S₂ (e.g., the speed that the compressor 130 was operating at just before the maximum allowable compressor speed became greater than the first speed S₁). There are numerous ways that the second speed S₂ can be determined and stored in the memory in operative communication with the controller 120. For example, this second speed S₂ can be determined through a rolling multi-point average of the compressor speed over a predetermined time interval (e.g., such as about 30 second or less), the second speed S₂ can be substantially equal to the minimum speed of the compressor 130 over a predetermined time interval, the second speed S₂ can be substantially equal to the maximum allowable compressor speed 440 when the maximum allowable compressor speed 440 is less than the first speed S₁ (e.g., such as in region 415), the second speed S₂ can be substantially equal to the demand speed of the vapor compression system 100. The second speed S₂ can change with time. The second speed S₂ can be less than the first speed S₁ at all times.

Both the compressor speed without implementation 405 and the compressor speed with implementation 410 trace the maximum allowable compressor speed 440 when it decreases below the first speed S₁ for a second time at t₃. The two traces (405 and 410) continue together, following the maximum allowable compressor speed 440 until it becomes greater than the first speed S₁ at t₄. Here, again the two traces diverge as the compressor speed without implementation 405 increases back to the first speed S₁ and the compressor speed with implementation 410 remains at a newly established second speed S₂ₙ (e.g., established as the maximum allowable compressor speed 440 just prior to it becoming greater than the first speed). Although the newly established second speed S₂ₙ can be numerically different than the initial second speed S₂, both remain below the first speed S₁.

Once the startup condition is satisfied, the speed of the compressor 130 can be adjusted to the demand speed S_{D} to balance the thermal output of the vapor compression system 100 with the demanded thermal output. For example, once the startup condition is satisfied at t₅, both the compressor speed without implementation 405 and the compressor speed with implementation 410 can be adjusted to the demand speed S_{D}. By maintaining the speed of the compressor 130 at a speed less than the first speed S₁ and not increasing back to the first speed S₁, pressure pulses in the vapor compression system 100 such as those associated compressor speed spikes 412 can be avoided.

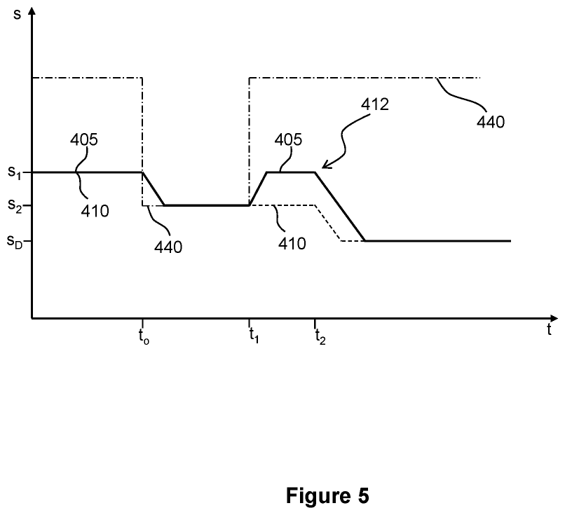

FIG. 5 is a schematic illustration of operating parameters of the vapor compression system 100 with and without implementation of method 300. Again, the compressor speed without implementation 405 is denoted by the solid line, the maximum allowable compressor speed 440 (e.g., as determined by the controller 120 based on conditions of the refrigerant loop 110) is denoted by the dot-dashed line, the compressor speed with implementation 410 is denoted by the dashed line, the first speed is denoted S₁, the second speed is denoted S₂, and the demand speed is denoted S_{D}. In this example, the compressor 130 is operating at the first speed S₁ until a system parameter causes the maximum allowable compressor speed 440 to drop below the first speed S₁ at t₀ to a second speed S₂. Both the compressor speed without implementation 405 and the compressor speed with implementation 410 then are reduced and track the maximum allowable compressor speed 440 until it increases above the first speed S₁ at t₁. Once the maximum allowable compressor speed 440 increases above the first speed S₁ the compressor speed without implementation 405 increases back to the first speed S₁ while the compressor speed with implementation 410 stays at the seconds speed S₂. By maintaining the speed of the compressor at the second speed, pressure pulses in the vapor compression system 100 such as those associated compressor speed spikes 412 can be avoided. Once the startup condition is satisfied at t₂, both the compressor speed without implementation 405 and the compressor speed with implementation 410 can be adjusted (e.g., decreased) to the demand speed S_{D}.

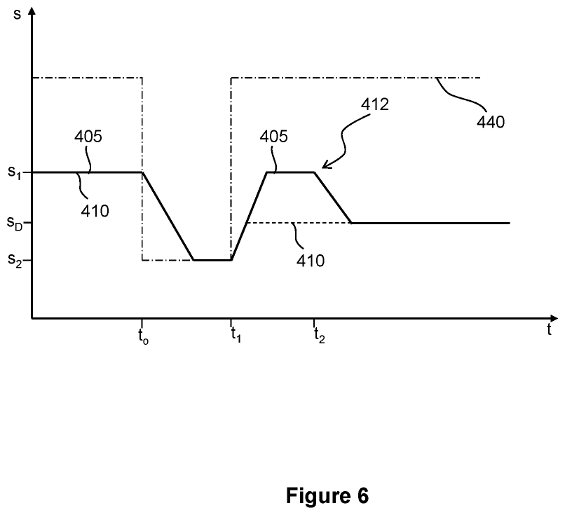

FIG. 6 is a schematic illustration of operating parameters of the vapor compression system 100 with and without implementation of method 300. Again, the compressor speed without implementation 405 is denoted by the solid line, the maximum allowable compressor speed 440 (e.g., as determined by the controller 120 based on conditions of the refrigerant loop 110) is denoted by the dot-dashed line, the compressor speed with implementation 410 is denoted by the dashed line, the first speed is denoted S₁, the second speed is denoted S₂, and the demand speed is denoted S_{D}. In this example, the compressor 130 is operating at the first speed S₁ until a system parameter causes the maximum allowable compressor speed 440 to drop below the first speed S₁ at t₀ to a second speed S₂. Once both the compressor speed without implementation 405 and the compressor speed with implementation 410 ramp their speed down after to they track the maximum allowable compressor speed 440 while it is less than the first speed S₁ until it increases above the first speed S₁ at t₁. Once the maximum allowable compressor speed 440 increases above the first speed S₁ then compressor speed without implementation 405 increases back to the first speed S₁ while the compressor speed with implementation 410 increases to the demand speed S_{D}. By maintaining the speed of the compressor 130 at a speed less than the first speed S₁, pressure pulses in the vapor compression system 100 such as those associated compressor speed spikes 412 can be reduced. Once the startup condition is satisfied at t₂, the compressor speed without implementation 405 can be adjusted (e.g., decreased) to the demand speed S_{D} while the compressor speed with implementation is already operating at the demand speed S_{D}. Following startup, the compressor 130 can operate to maintain a parameter of the vapor compression system, such as temperature of the space 200, by following the demand speed S_{D}.

Optionally, the variable speed drive 135, the controller 120, or both can include a rate limiter to limit the rate at which the speed of the compressor 130 can be changed. For example, one of the variable speed drive 135 or the controller 120 can be configured to limit the rate at which the speed of the compressor 130 is changed to less than or equal to about 100 rpm/sec, or about 90 rpm/sec, or about 80 rpm/sec, or about 70 rpm/sec, or about 60 rpm/sec, or about 50 rpm/sec, or about 40 rpm/sec, or about 30 rpm/sec, or about 20 rpm/sec, or about 10 rpm/sec, or about 5 rpm/sec. Further, the rate limiter can be applied to either increases or decreases in the speed of the compressor 130. Still further, the magnitude of the rate limit for speed increases can be different than the magnitude of the rate limit for speed decreases. For example, a speed increase rate limit can be set to 50 rpm/sec while a speed decrease rate limit can be set to 25 rpm/sec, or 75 rpm/sec, or any such combination as is deemed appropriate for the compressor 130 and the overall design and operation of the vapor compression system 100. When rate limiting is not implemented the controller 120 can utilize other control approaches to bring controlled variables within desired range such as proportional, integral, or differential controllers or combinations including at least one of the foregoing. These control approaches can generate an output speed signal having a magnitude corresponding to the deviation of a system parameter from its set point (e.g., output air temperature).

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of operating a vapor compression system configured for environmentally conditioning a space comprising:
providing a compressor of the vapor compression system with a variable speed drive configured to control a speed of the compressor and correspondingly a flowrate of a refrigerant flowing through the compressor,
operating the compressor at a first speed in response to a start command,
determining a demand speed of the compressor based at least in part on a user selected target value for an environmental condition within the space,
determining a maximum allowable compressor speed of the compressor based at least in part on a condition of a parameter of the vapor compression system,
reducing the speed of the compressor from the first speed to a second speed corresponding to the maximum allowable compressor speed when the maximum allowable compressor speed is less than the first speed,
maintaining the speed of the compressor below the first speed when the maximum allowable compressor speed is greater than the first speed, and
operating the compressor at the demand speed once a startup condition is satisfied.

2. The method of claim 1, wherein the maintaining the speed of compressor below the first speed further comprises operating the compressor at the demand speed when the demand speed is greater than the second speed.

3. The method of claim 1, wherein the maintaining the speed of the compressor below the first speed further comprises operating the compressor at the second speed when the demand speed is less than the second speed.

4. The method of claim 1, wherein the startup condition comprises increasing a discharge superheat value of the vapor compression system to a threshold discharge superheat value.

5. The method of claim 1, wherein the startup condition comprises waiting for a first time period to expire.

6. The method of claim 1, wherein the startup condition comprises increasing a discharge superheat value of the vapor compression system to a threshold discharge superheat value and waiting for a first time period to expire.

7. The method of claim 1, wherein the determining the maximum allowable compressor speed of the compressor further comprises comparing at least one of a suction pressure of the compressor, a discharge pressure of the compressor, a compression ratio of the compressor, a compressor discharge temperature, or a combination comprising at least one of the foregoing to a threshold condition.

8. The method of claim 1, wherein the reducing the speed of the compressor further comprises decreasing the speed of the compressor according to a downward ramp rate.

9. The method of claim 1, wherein operating the compressor at the demand speed further comprises adjusting the speed of the compressor according to an upward or downward ramp rate from the second speed to the demand speed.

10. The method of claim 9, wherein the upward ramp rate and the downward ramp rate have the same magnitude but opposite signs.

11. The method of claim 1, wherein the condition of the parameter of the vapor compression system comprises a high suction pressure of the compressor, a low suction pressure of the compressor, a high discharge pressure of the compressor, a low discharge pressure of the compressor, a high compression ratio of the compressor, a low compression ratio of the compressor, a low compressor discharge temperature, a high compressor discharge temperature, or a combination comprising at least one of the foregoing.

12. A vapor compression system configured for environmentally conditioning a space comprising:
a compressor, an indoor heat exchanger, and outdoor heat exchanger, and an expansion valve disposed in a closed loop in operable communication with one another, wherein the indoor heat exchanger is disposed in thermal communication with the space,
a variable speed drive disposed in operable communication with the compressor and configured for adjusting a speed of the compressor, and
a controller in operable communication with the variable speed drive and a sensor configured to determine a condition of a parameter of the closed loop, wherein the controller is configured to operate the vapor compression system according to the method of any one of the preceding claims.

13. A vapor compression system configured for environmentally conditioning a space comprising:
a compressor, an indoor heat exchanger, and outdoor heat exchanger, and an expansion valve disposed in a closed loop in operable communication with one another, wherein the indoor heat exchanger is disposed in thermal communication with the space,
a variable speed drive disposed in operable communication with the compressor and configured for adjusting a speed of the compressor,
a controller in operable communication with the variable speed drive and a sensor configured to determine a condition of a parameter of the closed loop, wherein the controller is configured to determine a demand speed of the compressor based at least in part on a user selected target value for an environmental condition within the space, determine a maximum allowable compressor speed of the compressor based at least in part on the condition of the parameter, reduce the speed of the compressor from a first speed to a second speed corresponding to the maximum allowable compressor speed when the maximum allowable compressor speed is less than the first speed, maintain the speed of the compressor below the first speed when the maximum allowable compressor speed is greater than the first speed, and
operate the compressor at the demand speed once a startup condition is satisfied.

14. The vapor compression system of claim 13, wherein the controller is configured to operate the compressor at the demand speed when the demand speed is greater than the second speed.

15. The vapor compression system of claim 13, wherein the controller is configured to operate the compressor at the second speed when the demand speed is less than the second speed.

16. The vapor compression system of claim 13, wherein the startup condition comprises a discharge superheat value of the vapor compression system being greater than or equal to a threshold discharge superheat value.

17. The vapor compression system of claim 13, wherein the startup condition further comprises waiting for a first time period to expire.

18. The vapor compression system of claim 13, wherein the startup condition comprises a discharge superheat value of the vapor compression system being greater than or equal to a threshold discharge superheat value and waiting for a first time period to expire.

19. The vapor compression system of claim 13, wherein the controller is configured to determine the maximum allowable compressor speed by comparing at least one of a suction pressure of the compressor, a discharge pressure of the compressor, a compression ratio of the compressor, a compressor discharge temperature, or a combination comprising at least one of the foregoing to a threshold condition.
